(19) United States
(12) Patent Application Publication
(10) Pub. No.: US 2012/0330817 A1
(43) Pub. Date: Dec. 27, 2012

(54) RISK MANAGEMENT SYSTEM AND METHOD FOR MONITORING AND CONTROLLING OF MESSAGES IN A TRADING SYSTEM

(75) Inventors: Slav Brkic, Toronto (CA); Stephen Plut, Toronto (CA)

(73) Assignee: INTEGRATED TRANSACTION SYSTEMS LTD., Toronto, ON (CA)

(21) Appl. No.: 13/582,625

(22) PCT Filed: Dec. 8, 2010
(86) PCT No.: PCT/IB10/55671

§ 371 Date: Sep. 4, 2012

Related U.S. Application Data
(60) Provisional application No. 61/419,102, filed on Dec. 2, 2010.

(51) Int. Cl. G06Q 40/04

(52) U.S. Cl. 705/37

(57) ABSTRACT

Methods and systems are disclosed for risk management in electronic trading where user messages are collected by at least one inspection engine which monitors one or more parameters of the user messages. The decision to manipulate the user messages is based on whether one or more of the parameters or a risk factor exceeds a predetermined range limit. The user messages are then transmitted to a trading engine where the user messages with manipulated parameters are rejected and the user messages with unchanged parameters are processed normally. By eliminating the need to maintain state with the message protocol of the user messages, the transport speed of such user messages is improved.

### PRIORITY CLAIM AND RELATED APPLICATIONS

This application claims priority to U.S. Ser. No. 61/419,102, a provisional application filed Dec. 2, 2010 and PCT/IB2010/055671, a PCT application filed Dec. 8, 2010. Said applications are incorporated by reference herein in their entirety.

### BACKGROUND OF THE INVENTION

1. The Field of the Invention

The present invention generally relates to a trading system and more specifically, discloses a system and method for monitoring and controlling of messages in a trading system.

2. Background Art

Over the recent past, there has been an uptrend in electronic security and commodity trading leading to high frequency trading (HFT). One drawback in HFT is related to the risks introduced by latency in a trading system where the HFT is executed. In order to reduce latency, more and more traders or clients desire to access trading engines directly without going through their brokers/dealers system. As a result, a new area of trading called sponsored access (or sponsored direct market access) has come into common use. The problem with not going directly through the broker/dealer is that there is no way for a broker/dealer to control or limit the order flow getting into the market in real time. Since the final orders that are either placed by the clients directly or their respective brokers/dealers engine to a trading engine are processed under the name of brokers/dealers, the brokers/dealers put themselves at high risk by not being able to control or limit order flow.

By way of example, a client sends an order directly to an Exchange using the broker's name. The order is executed at the Exchange and the execution is sent to the trader. The broker has no knowledge of the execution because the trader is not using the broker's infrastructure to send orders to the Exchange. However, from the Exchange's perspective, it is the broker who has executed the transaction and therefore the broker is liable for the trade.

Many securities firms currently manage their risk and their clients' risk on an end-of-day basis. This occurs when firms' securities trading systems do not incorporate an adequate real-time risk management system or when their clients use their own securities trading systems to execute trades and report trade executions at the end of the day. The intraday exposure to trades could exceed risk profiles established by contractual, statutory and/or regulatory guidelines. These risks could result in the inability of the firm to meet capital adequacy requirements, resulting in the firm having to take contractual action to protect itself that could be detrimental to its clients or the firms having to take client exposures onto its own books to address the risk. For example, if one of a clearing firm's clients were to execute a series of large short trades (exceeding their buying power) in a hard to borrow security (possibly not knowing it had been added to the clearing firm's hard to borrow list) and that the security's price subsequently rose significantly during the day on some unexpected good news reports, the clearing firm would be exposed not only to significant losses from the transactions themselves, but also to regulatory action for inadequate risk management procedures.

A broker has to monitor the trader's activities to comply with business and regulatory trading rules. Since traders are using multiple disparate systems, the broker does not have a real-time centralized view or the ability to control order messages to manage risk. Although no one trader may be violating the trading parameters or rules, the combined activities of all the traders could lead to a violation of the trading parameters or rules. Since the market price changes dynamically, a possible close out of position could lead to monetary loss. Hence the ability to timely monitor and control order messages is required.

Additionally, a broker has to comply with the rules established by its clearing broker. Such rules relate to, but are not limited, to buying power, margins, hard-to-borrow symbols, short selling, and restricted securities. The broker has to monitor its clients' trading activity. A trader may short sell a hard-to-borrow security from its own proprietary system. The clearing broker may decline to settle the trade and the correspondent broker could be liable.

The problem of controlling access to the trading systems is usually solved by direct market access (DMA) or an order management system (OMS). However, the drawback of these systems is that they are monolithic. If multiple flows of orders into multiple exchanges need to be managed, all the orders have to be sent to one location. These systems are further connected to each of the required destinations. Further, these systems function at an end point of the messaging protocols used to transmit the data. Exemplary standard messaging protocols are Financial Information eXchange (FIX), Security Transfer Association Medallion Program (STAMP) or Common Message Switch (CMS). These systems fully receive, process and forward or reject each message in the order flow. In addition, each of these systems needs to maintain a state on all message transmissions. The centralized design of these systems slows the flow of order and response messages and hence adds to the latency.

Therefore, a method or system is needed that can monitor and control the trading messages in real time or near real time at considerably higher speeds and reduced latency as compared to the existing systems.

### SUMMARY OF THE INVENTION

Accordingly, the present invention is directed to a method and a system used in electronic trading that substantially overcomes the problems of the prior art. The invention optimizes the risk factor and minimizes latency associated with trading. The present invention comprises a risk management system that is incorporated in a method and a system for reducing latency. Such a system enables broker to halt trade orders immediately in real time or near real time as trade orders are executed, thereby enabling the broker to manage his/her clients' trading activities appropriately. The present invention allows the broker to manage credit, market and operational risk for himself/herself and for his/her clients. The operational efficiencies of the present invention enables the broker to take on a much larger client base while reducing the overall risk resulting in increased revenues and greater return on investment.

The present trading system comprises at least one inspection engine and a trading engine, wherein at least one first inspection generates at least one user message corresponding to an outstanding trade order submitted by a client of the user device. The user message comprises a risk factor and at least one parameter.

The present method for controlling the user message comprises:
a. a calculating step of calculating the risk factor wherein a first risk factor of the at least one user message is calculated based on current market data and a current order status of all outstanding orders and a second risk factor of at least one previous user message is calculated based on said current market data and said current order status of all outstanding orders, wherein the current market data is received by the at least one inspection engine from at least one outside source relating to the at least one user message and the at least one previous user message;
b. a comparing step of comparing the risk factor with a predetermined range limit of risk factors and comparing the at least one parameter of the at least one user message with a predetermined range limit of the at least one parameter, whereby if a first condition exists such that the risk factor exceeds the predetermined range limit of the risk factor, the at least one parameter of the at least one user message is modified to an invalid value or if a second condition exists such that the at least one parameter exceeds the predetermined range limit of the at least one parameter, the at least one parameter is modified to an invalid value, or a combination of the first and second conditions whereby the at least one user message is treated as “out of range;”
c. a transmitting step of transmitting the at least one user message via a first communication means to a server of the at least one trading engine, wherein the server maintains a list of outstanding trade orders, whereby if the at least one user message is treated as “out of range,” the at least one user message is rejected and if the at least one user message is not treated as “out of range,” the at least one user message is added to the list of outstanding trade orders, thereby eliminating the need for maintaining states of the at least one user message and reducing an overhead corresponding to the transmitting step, wherein the overhead is incurred due to the need to specify the way the at least one user message is transmitted to the server; and
d. a receiving step of receiving at least one response message by the at least one inspection engine in response to the at least one user message, whereby the at least one response message comprises a normal response comprising one of an execution state, a change in said at least one parameter responsive to the at least one user message and a combination thereof, if the at least one user message is not rejected by the at least one trading engine or an error response if the at least one user message is rejected by the at least one trading engine.

It is an object of the present invention to provide systems and methods for providing high speed message transactions and reduced latency in trading environments.

It is another object of the present invention to provide systems and methods for risk management by monitoring selected parameters of the trading messages at the intermediate level of the message protocols and manipulating them where the parameters or risk factor exceed a predetermined range limit.

It is another object of the present invention to provide systems and methods for risk management that employ inspection engines interposed at the transport layer level of a communication layering model to monitor and control user messages. The inspection engine monitors the parameters of an order and response messages from a trading engine and depending upon whether the message parameters or risk factor exceed their corresponding predetermined range limits, the decision to manipulate message parameters is made. User messages are then forwarded to the trading engine where the user messages with manipulated parameters are rejected and other user messages are processed normally. This leads to faster processing of the user messages and hence the overall latency is significantly reduced. Also since the decision on whether to reject or accept a particular order is made at the transport layer level, and not at an end point of the communication protocol in which the user messages are transmitted, there is no need to maintain states on the actual communication protocol. Hence, any latency added due the need to maintain states is avoided.

It is another object of the present invention to provide systems and methods for providing high speed trading message transactions and reduced latency in trading environments that employ a decentralized design in which different inspection engines are physically separated and provide their current information to other inspection engines. Such designs provide operational flexibility not found in a centralized or dedicated trading system.

It is another object of the present invention to provide systems and methods for providing high speed trading message transactions and reduced latency in trading environments that employ a decentralized design in which multiple inspection engines are physically separated and provide their collected current market data to a central node. This central node provides the collected information to other functionally connected inspection engines that require it.

It is another object of the present invention to provide systems and methods where a management workstation is connected to a central node so as to provide manual access to current trading flow statistics, gateway status and other pieces of collected information. This management workstation allows a broker to keep track of the risk factor for his/her clients, place orders on behalf of the clients, set a predetermined range limit on a risk factor and shut down orders for any specific user, symbol or gateway.

It is yet another object of the present invention to provide the cause of a user message rejection by a trading engine to a client.

These and other objects, features, and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram depicting message flow in a single-market scenario according to the present invention.

FIG. 2A illustrates a TCP/IP layering model.

FIG. 2B illustrates an OSI layering model.

FIG. 3 is a block diagram depicting message flow in a multi-market scenario according to the present invention.

FIG. 4 is a flowchart depicting message flow within a trading system according to the present invention.

FIG. 5 is a block diagram depicting one embodiment of the present invention in a single-market scenario.

FIG. 6 is a block diagram depicting one embodiment of the present invention in a multi-market scenario.

### PARTS LIST

100, 300—trading system
101—client 1
102—client 2
103, 103′—inspection engine
104—control engine
105—management workstation
106, 106′—trading engine
207—application layer
208—transport layer
209—internet layer
210—link layer
211—application layer
212—presentation layer
213—session layer
214—transport layer
215—network layer
216—data link layer
217—physical layer
426—step of accepting TCP/IP connection from client system
427—step of establishing TCP/IP connection to Exchange system
428—step of listening for new order/Cancel Former Order/Cancel Messages
429—step of retrieving parameters of order
430—step of adding parameters to outstanding order
431—step of determining if message parameters/risk factor exceeds predetermined range limit
432—step of forwarding the message to the trading engine/Exchange
433—step of determining if message has manipulated parameter(s)
434—step where response message is sent to the inspection engine
435—step where the response message is used to update the order status of all outstanding orders which helps in calculating the risk factor and traded volumes

### PARTICULAR ADVANTAGES OF THE INVENTION

This invention relates to the monitoring and controlling order flow in to trading systems. The message protocols used in traditional trading system communications are point to point protocols including FIX, STAMP, CMS, and the like. The areas of application include equity trading, options trading, futures trading and the like. The present invention is particularly effective in risk management in the trading environment as it allows a broker to limit or control order flow to the market.

The most prominent advantages of the present invention include monitoring and controlling of the order information at the transport layer level of a network stack as compared to prior art methods of monitoring at an end point of a user message protocol. In addition, the inspection engine can be embedded within a trading engine if so desired. This feature allows the system of the present invention to remain stateless (i.e. there is no need to maintain the state on transmitting a user message to a trading engine) which leads to reduction of latency and hence, faster trading transactions. Also, the present invention makes use of a decentralized design as compared to central design of the prior art, where all the order messages had to be sent to a single location, thereby reducing the latency time further.

The present invention facilitates risk management by allowing a broker to control or limit the order flow into a market. The broker can stop high risk orders from hitting the trading engine thereby reducing the chances of any risk or damage happening to clients, brokers or trading engines.

### DETAILED DESCRIPTION OF A PREFERRED EMBODIMENT

The present invention includes a risk management system and method for monitoring and controlling securities, currency and commodities transactions and the transfer of trading messages relating to these transactions in a trading environment. The method and system described herein preferably occur using systems and components shown in the figures provided, although one skilled in the art will appreciate that many variations of the system may be implemented without departing from the scope of the invention.

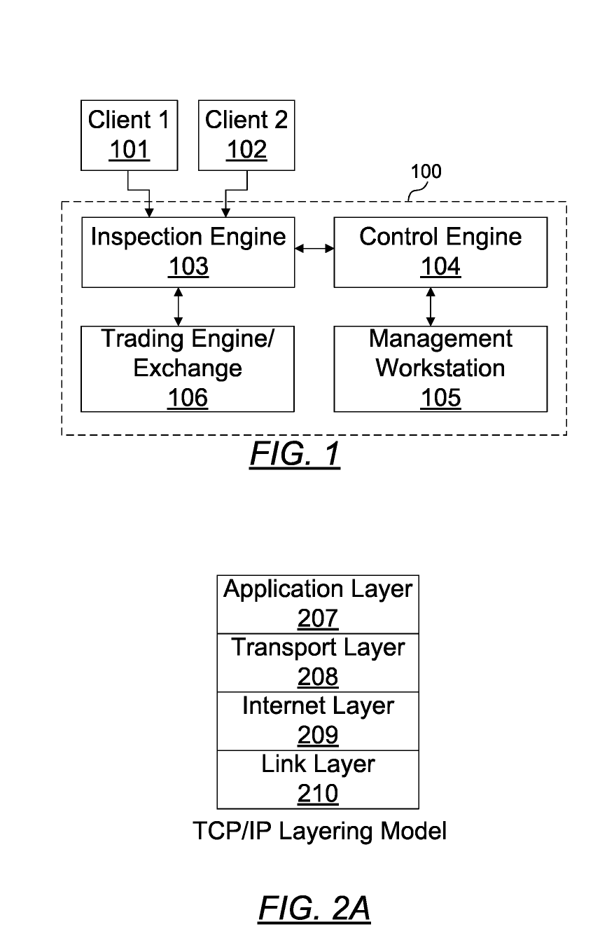

FIG. 1 shows one embodiment of the present invention in which a client 101, 102 interacts with a trading exchange 106 via an inspection engine 103. In the present invention described herein, the term “client” or “trader” is any user of a trading system including a trading house, an individual trader, or one or more groups of traders sharing a membership. Clients 101, 102 may run an additional trading interface not including the inspection engine 103 to help them in transacting various trading messages within the trading system. The client can trade assets including futures, shares, commodities, options, and currencies. In the embodiment shown in FIG. 1, only two users are shown but it will be apparent to one skilled in the art that any number of users can be made to interact within the trading system 100. The exchanges may include commodity exchanges, currency exchanges or stock exchanges. Exemplary exchanges are NYSE, NASDAQ, Euronext, CBOT, Eurex, LIFFE, CME, Xetra, Island, Toronto Stock Exchange, Alpha Trading, Pure Trading, and the like. In addition to the exchanges, trading may take place on Electronic Communication Networks (ECNs) and Alternative Trading Systems (ATSs).

In one instance, a message flows from a client 101, 102 to the trading engine 106. Each of clients 101, 102 communicates a trading message/order to an inspection engine 103. It shall be understood that the terms “user message,” “trading message” and “order” are used interchangeably within this disclosure to indicate an object of communication that is generally initiated by a client, received at an inspection engine and transmitted to a trading engine to indicate an order. Various trading interfaces can be used to interact with different network technologies and topologies to aggregate desired information. In some cases, a trading interface must be able to learn the particular private messaging infrastructure to monitor and record appropriate activity. In other cases, a trading interface will need to know how to interact with other systems to make requests on a timed or event driven basis. This interaction could involve message-based inquiries, direct access to databases or other transaction-based requests. When relevant information related to a given situation, such as a transaction, is found on one or more monitored networks, the trading interface collects the relevant information and, if necessary, packages, or translates it into an appropriate normalized format. For example, the widely known standard messaging protocols could be used to package or translate the relevant information such as FIX, STAMP or CMS, however, it is to be understood that any suitable protocol may be used. Each of these protocols is a message based and point to point protocol.

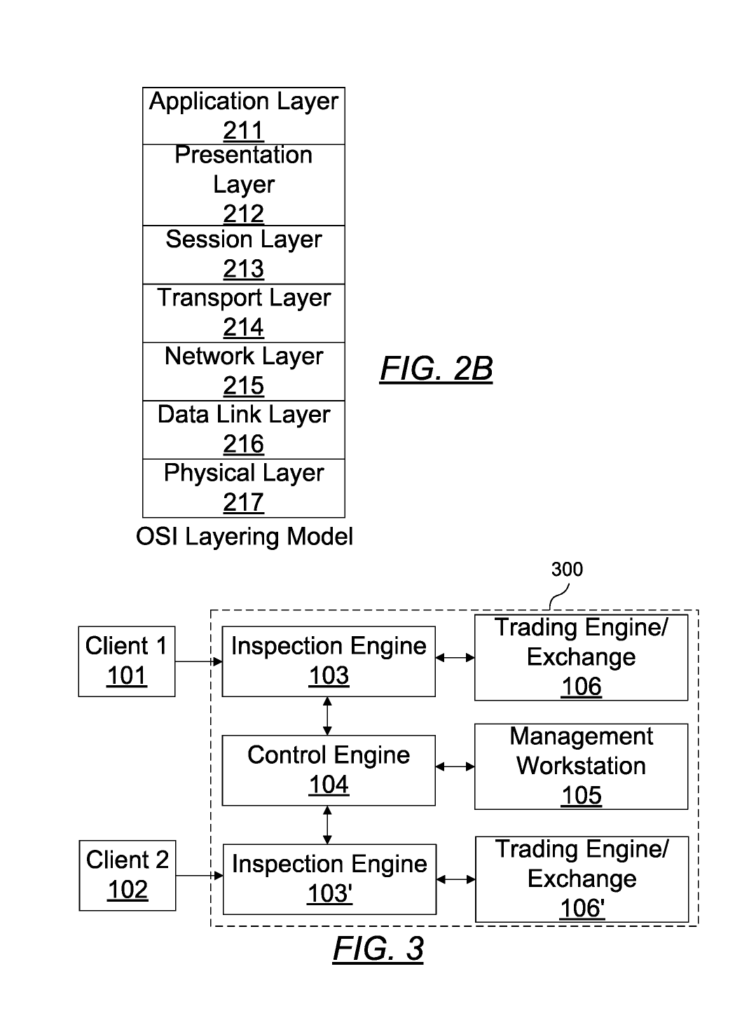

An inspection engine 103 is a computer program or software application that sits between the clients 101, 102 and the trading engine or exchange 106 in the stream of message protocol. It operates at the transport layer level of a network stack of the trading system. The transport layer may be implemented according to an Open Systems Interconnection (OSI) layering model as shown in FIG. 2B, TCP/IP layering model as shown in FIG. 2A, UDP/IP protocol, or any other data communication protocol well known in the art. The user message may include without limitation, for example, new order, cancel former order (CFO), cancel, and other well-known financial transaction messages. Inspection engine 103 collects order information going into the trading system via interaction with relevant networks within the defined timeframes for such networks and with the permission of the managers or controllers of such networks. This order information may come from disparate networks in real-time, near real time and/or in batch mode. For example, in real time, the order information could be collected from disparate networks via “drop copies.” In near real time, the order information is collected within some short period of time. A batch mode can be set to an increment of time based on each network's business processes. The collected order information can also include information from networks that reflect summarized and/or real-time data that relates to, but may not be directly impacted by, the particular situation or transaction being monitored. For example, securities market prices may be relevant to assessing the impact of a particular situation or transaction although the particular situation or transaction may not, in and of itself, impact securities market prices. This collected information gives the count on the number of orders, volume of shares and order value in a pending or booked state, and any traded share volume and value.

In the present invention, a risk management system and method is provided to monitor and manage risk such as buying power/threshold restrictions, restricted and hard to borrow securities risk management, short sell restriction risk management, single order quantity limit management, single order value risk management, and realized and unrealized profit and loss. The risk management system can be loaded with clients' overnight buying power and stock positions. During the day, the computer system will receive copies of all client execution messages in real-time either directly from exchanges or from manual entries by authorized users at a management workstation 105 with regard to transactions that may not be received electronically during the trading day. The information collected by the inspection engine 103 may also be broken down by symbols, users and exchanges to aid in the collection of information used to enforce established access rules. The inspection engine 103 may regularly obtain outside information regarding current market state of, for example, engine best ask or bid prices, national best ask or bid, current buy or sell value, volatility of a particular asset, profit and loss information, margin, volumes and the like from various outside sources including exchanges and third parties. This outside information helps to determine the value of shares or market orders and also helps in determining if the order placed by the clients 101, 102 will violate trade through or any other obligations. An additional feature of the present trading system 100 is the ability to use user message rate as a tool to control the validity of a user message. For example, the inspection engine 103 has the ability to modify the period at which user messages related to an order of a specific trader or stock are transmitted to ensure they are rejected by the trading engine. As an example, if a trading engine is configured to reject successive identical (for example, identical symbols and volumes) user messages spaced at a period of lower than a minimum period, any successive identical user messages having a period of less than the minimum period will be rejected by the trading engine. Such safeguard is typically implemented at the trading engine to prevent unintended order submissions due to faulty software execution in sending user messages. An example of faulty software execution is an infinite loop which causes a user message to be sent multiple times at high rate.

In one embodiment not shown and in the absence of a control engine 104, the risk management system and method is configured to operate within the inspection engine 103. In this instance, the inspection engine 103 is configured to collect and process data. In another embodiment, the risk management system is configured to run in a control engine 104 as shown in FIG. 1. The control engine 104 acts as a central point for receiving collected information from the inspection engine 103 on a real time or batched basis and comparing the collected information against predetermined range limits of parameters and a risk factor. The function of the control engine 104 as a central point in the trading system 100 will become apparent with the presence of multiple inspection engines as will be disclosed in further embodiments. Exemplary parameters and risk factor include parameters or rules that are identified by clients with regard to certain risks, trends, outages, uses, or other desired limits. The control engine 104 can also leverage the capabilities of external analysis systems which may be commercially available to address particular risk, trend, outage, use scenarios, or other determining events. For example, an external analysis system could include a third party risk system for a particular class of securities or group of clients, or other class. These parameters or rules and external analysis systems can be managed to set overall criteria for a group of users, specialized criteria for individual users at any level within a defined hierarchy, or other criteria.

Referring again to FIG. 1, the control engine is further functionally coupled to a management workstation 105. In one embodiment, the control engine 104 is located remotely from the inspection engine 103 and the management workstation 105. The management workstation 105 provides manual access to all the information collected at the control engine 104. The management workstation 105 is configured to connect to the control engine 104 and access current trading flow statistics, gateway status or any other piece of collected information. The management workstation 105 provides an interface to allow a broker/administrator to perform various functions such as setting the predetermined range limits for the order parameters/risk factor, monitoring of parameters for any specific client, placing an order on behalf of the client, symbol or gateway, monitoring the value of the risk factor for the current client, blocking the order for any specific client, symbol or gateway, and the like. For example, when a user places an order into an inspection engine, the broker can use the current market data such as best ask or bid prices, national best ask or bid, current buy or sell value, volatility of a particular asset, profit and loss information, margin, volumes, and the like which is obtained at the inspection engine to determine the risk factor of the placed order. If the risk factor of the placed order exceeds the predetermined range limit of the risk factor, the administrator/broker can mark and manipulate the order so that it gets rejected at the trading engine.

In one embodiment, on receiving an order or one or more user messages from the clients 101, 102, the inspection engine 103 calculates a value corresponding to the risk of the placed order. The value may be calculated before an order is received such that a risk component can be readily incorporated after an order has been placed. Risk components independent of the specifics of a placed order can be calculated or otherwise made available to reduce latency in obtaining this value. This value may include the order status of outstanding orders, status of existing filled and unfilled assets, any specific parameters associated with the order, order type, and the like. The value may further be based on profit and loss data, margin, position, outright clip size and spread clip size. This value may further include a risk factor on the current portfolio of the client before an order is received. In addition, the value may include a current risk factor of all the previous user messages based on current market data and current order status of all outstanding orders. The data used to calculate the risk factor is preferably stored in a memory of the inspection engine 103 or the control engine 104 for further reference. This stored data helps in faster calculation of a value corresponding to a risk factor during real-time trading. In a preferred embodiment, the risk factor comprises a monetary value or a margin for the trading assets corresponding to the placed order.

In another embodiment, the value is calculated by a Standard Portfolio Analysis of Risk (SPAN) calculation method. This method of calculating the risk factor on a portfolio is well known in the art and was developed by the Chicago Mercantile Exchange. This method is generally used at the end of a trading day to calculate the risk factor on orders placed in the market. This method takes into account various parameters set by a clearing house to determine the maximum loss or risk for a particular order/portfolio over a day's trading. The SPAN system is generally used to calculate the available margin requirements on the trader's margin account at the end of a trading day. SPAN calculates the potential risk and margin requirements by taking into account different market conditions and thereby all hypothetical gains and losses that a particular order/portfolio might undergo. Since SPAN takes into account many different possibilities of the market conditions, it is an intensive calculation process, it is not possible to employ this method in the real time trading during the trading day as it might incur and/or cause severe delays in communication between the inspection engine 103 and the trading engine 106.

As will be readily appreciated by those skilled in the art, other parameters may be monitored and controlled as well, such as, for example cash position for each account, stock position for each account, account details, hard to borrow (HTB) symbols and quantity limit, buying power, single order quantity limit, single order value limit, whether short selling is allowed, stocks in which trading is not allowed, quantity limit in hard to borrow stocks, selling stock without inventory, portfolio concentration, heavy exposure in illiquid symbols, trading in low priced security, traded volume as percentage of market volume, trading in highly volatile securities and the like. The value can be summarized as follows:

Value (Risk factor calculated for a current user message)=risk value calculated for the current user message based on one or more risk components of the current market data and current order status of all outstanding orders+risk value calculated for previous user messages based on one or more risk components of the current market data and current order status of all outstanding orders.

In one embodiment, a separate filter is used in addition to the use of a risk factor and parameters associated with a user message. Filter criteria used for the filter include but not limited to restricted symbol lists, trade through verification and manual do-not-trade instructions.

Subsequently, the value is compared with a predetermined range limit of the risk factor. If the placed order is found to cause at least one user message parameter, risk factor, or both to exceed their corresponding predetermined range limits or if any of the filter criteria is not fulfilled, then at least one parameter of the user message is manipulated. A user message that is determined to require manipulation is considered to be “out of range.” The predetermined range limit for a user message parameter or a risk factor is preferably set by a broker. The range limit can either remain constant or may vary depending upon market conditions. This process helps in detection of a high risk order at an intermediate stage and thereby helps in taking appropriate action so as to avoid such order from getting processed at the trading engine 106. The manipulation of a user message parameter is performed in such a way that places the corresponding order to get rejected at the trading engine 106. Examples of such manipulation include changing an order volume to 0, changing the symbol to an entity that is invalid or “out of range,” changing the UserId to an invalid value and the like. If manipulation to the user message is deemed unnecessary, the parameters of the user message will remain unchanged. In one embodiment, the steps of comparing risk factor and parameters to predetermined range limits and filtering are performed in the control engine 104. The user message is then communicated to the inspection engine 103 for subsequent transmission. Absent a control engine 104, these steps may be performed in the inspection engine 103.

The user message is then transmitted from the inspection engine 103 to the trading engine 106. The trading engine 106 receives the user message and verifies parameters of the user message. If the user message has been manipulated, the normal trading engine validation process would cause the user message to be rejected, otherwise the user message is processed normally. On processing the user message, the trading engine 106 generates one or more appropriate response messages which are transmitted back to the inspection engine 103. The response message may be a new order booked message, a CFO response, cancel reports and fill reports. The response message is used to update the current order status and parameters of all outstanding orders which help in calculating the traded volumes and the current client risk. The inspection engine 103 may further comprise a storage means for storing client information including a list of filled and unfilled orders (both pending and booked), traded volumes and the like, as this information helps in the calculation of future risk factor.

The method disclosed of the risk management system above provides a means to reject high risk orders, thereby lowering risk or damage to the client or broker. Further, since the decision on whether to reject or accept a particular order is taken at the transport layer 208 level and not at the end point of a message protocol such as the application layer 207, 211 of the TC/IP and OSI protocols as shown in FIGS. 2A and 2B, there is no need to maintain state on due to transmission of a user message. The application layer 207, 211 specifies how each software application connected to a network uses the network. When an application sends a user message across a network from the application layer 207, 211, the user message is broken up into manageable pieces called packets. Each of the data packets must contain addressing and other control information. From a performance perspective, this additional information is generally referred to as overhead. Overhead is generated in each of different protocol layers. Each of the layers through which a packet passes adds another component of overhead to the packet. Each layer adds a header and possibly a trailer that contains information for the corresponding layer at the destination. Reference is made to FIG. 89 and its associated disclosure of U.S. Pat. No. 6,718,535 for a representation of the TCP/IP layering model and its associated overhead incurred by each layer. Thus, operating packet transmission in the transport layer 208, 214 reduces the overhead and hence latency that would otherwise be incurred in the application layer and other protocol layers above the transport layer 208, 214. This results in very high speed message transactions in the trading environment making it possible to accommodate a very large number of high frequency traders in the trading system 100. Preferably, the user messages that are not marked to be rejected are forwarded to the trading engine 106 in less than 200 microseconds. Preferably, response messages from the trading engine 106 are forwarded equally as fast. However, the latency incurred in the response messages is largely outside the scope of the present invention since the trading engine 106 normally represents an Exchange which the present invention communicates with.

As already mentioned, the transport layer can be implemented using different networking models known in the art. Two of these models, namely, Transmission Control Protocol/Internet Protocol (TCP/IP) layering model and Open System Interconnection (OSI) are depicted in FIGS. 2A and 2B. The TCP/IP model as shown in FIG. 2A comprises primarily four layers, namely, application layer 207, which is the top most layer, then below that a transport layer 208, then an internet layer 209 below the transport layer 208 and finally, a link layer 210 at the bottom. A network refers to an underlying transport layer and all layers beneath the transport layer in the TCP/IP and OSI network models. An application can send or receive data across any of the networks to which its host system is attached.

The application layer 207 defines how different software applications connected to a network use the network. This layer acts as an interface to the clients 101, 102, that is, communication from an application running on a system originates at this layer. The application layer 207 provides semantic conversion between associated application processes. User messages from the application layer are passed to the transport layer 208. Transport layer 208 protocols provide reliable or unreliable communications protocols for client applications and ensure transfer of the user messages from the inspection engine 103 to the trading engine 106. Each of the user messages at the transport layer 208 is broken up into packets. These packets then move to the layer below transport layer, that is, the internet layer 209.

The Internet layer 209 consists of methods and protocols used to send the packets from the inspection engine 103 to the trading engine 106. Internet protocol (IP) uses network addresses to route the packets to a desired destination. The role of this layer is only to route the packets across the network connecting the inspection engine 103 and trading engine 106. The internet layer 209 organizes packets into frames and transmits them over the network. The link layer 210 beneath the internet layer 209 represents basic network hardware used to interconnect the inspection engine 103 and the trading engine 106. Conversely, upon receiving a response message represented as frames from the trading engine 106, the frames first reach the link layer 210 of the inspection engine 103 from where they move to the internet layer 209. The frames reaching the internet layer 209 are then converted to packets which then move to the transport layer 208. The transport layer 208 converts these packets to a response message which then moves to the application layer 207.

FIG. 2B illustrates the OSI layering model which comprises seven layers. The functionality of application layer 211 is similar to the application layer of the TCP/IP layering model. This is closest to a client 101, 102 and the communication from an application running on the inspection engine 103 originates at this layer. Communication in the form of a user message is then passed on to the presentation layer 212.

Presentation layer 212 is also sometimes called the syntax layer. This layer translates a user message between application and network layers. It does the proper formatting and encryption of the data to be sent to a network connecting the inspection engine 103 and the trading engine 106. The user message then moves to the session layer 213 which establishes and controls the communication between the inspection engine 103 and the trading engine 106. The transport layer 214 assists reliable or unreliable transfer of data from the inspection engine 103 to the trading engine 106. The various functions of this layer include flow control, error control, packetizing of the user messages, and the like. The packetized user message in the form of packets is transmitted to the network layer 215. The main function of this layer is the routing of packets across the network. It appends the header to the packets received and converts them to frames. These frames are then routed in a connectionless manner from the inspection engine 103 to the trading engine 106. The data link layer 216 provides the functional and procedural means to help transmit information between from the inspection engine 103 to the trading engine 106. It helps in detecting and possibly correcting errors that may occur in the physical layer 217. The physical layer 217 defines the physical and electrical specifications for the inspection and trading engines 103, 106. It helps in establishing connection with a communication medium.

FIG. 3 shows another embodiment of the present invention in which one or more clients interact with multiple exchanges via multiple inspection engines in a trading system 300. In this embodiment, two inspection engines 103, 103′ are connected to a control engine 104. Each of the inspection engines 103, 103′ is also connected to a trading engine 106, 106′. A management workstation 105 is connected to the control engine 104. The control engine 104 acts as a central point for receiving collected information from the inspection engines 103, 103′ on a real time or batched basis. The control engine 104 can also consolidate and/or redistribute collected information to the inspection engines 103, 103′ and the management workstation 105. This embodiment enables a single client to place multiple orders to multiple trading engines 106, 106′ via multiple inspection engines 103, 103′. In this embodiment, trades initiated by clients 101, 102 and entered through the inspection engines 103, 103′ are collected by the control engine 104 such that the trade portfolio of a broker is updated as a whole at control engine 104. The distributed nature of inspection engines 103, 103′ allows each inspection engine to indirectly (via the control engine 104) update all other inspection engines with their current information. The presence of a control engine 104 for communicating directly with each inspection engine 103, 103′ reduces the latency and risk that may arise from sending user messages to trading engines 106, 106′ without having reconciled the orders placed at inspection engines 103, 103′. In one embodiment, the inspection engines 103, 103′ are physically located in different locations. This distributed design provides operational flexibility. The management workstation 105 also provides manual access to all the information collected at the control engine 104 to the broker.

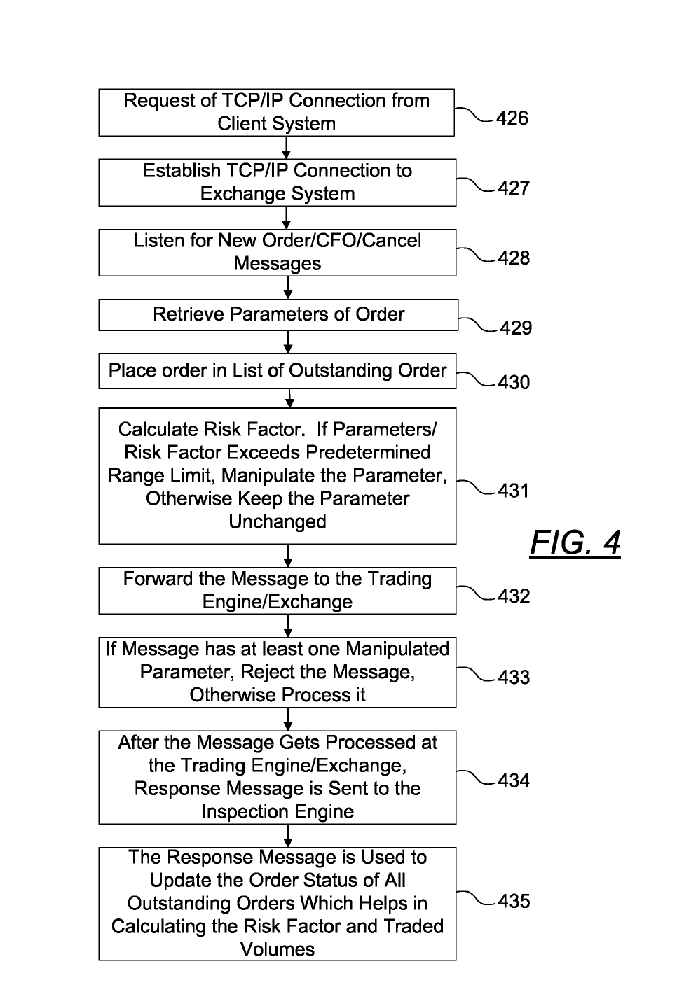

FIG. 4 is a flow chart depicting a example of the overall processing scheme, at the communication level, of a user message or order according to the present invention. Firstly, a TCP/IP connection is requested by client(s) interested in trading 426. The TCP/IP connection request is accepted and the connection with the requested exchange system is established 427. After the connection is established, the user message is transmitted by the client to the inspection engine 428. The user message transmitted may comprise a new order, CFO or cancel message. In the case of a new order or a CFO message, message parameters associated with the message are retrieved 429 and the order is placed in the list of outstanding orders 430. Message parameters include symbol, volume, price, UserId, exchange, account and the like. The current state of a client is derived from keeping track of all the gateways that the client uses to perform trading. Upon retrieving a user message from a client, a risk factor associated with the user message is calculated. The risk factor is then compared with a predetermined range limit for the risk factor and if either at least one message parameter or risk factor exceeds a pre-determined range limit, at least one parameter of the user message is manipulated 431. This manipulation is performed in order to ensure that the order gets rejected at the trading engine. Also, if any filter criteria are enabled, they are checked before forwarding the user message to the trading engine. These filter criteria include restricted symbol lists, trade through verification or manual do-not-trade instructions.

Upon checking the user message for parameter manipulation, the user message is forwarded by the inspection engine to the trading engine 432. The user message is processed depending upon its state. In the case where the user message has at least one manipulated parameter, the user message gets rejected by trading engine. Otherwise, in the case of no variation in at least one parameter of the received user message, it gets processed normally 433 and at least one appropriate response message is transmitted to the inspection engine 434. These response messages include new order booked message, CFO response, cancel reports and fill reports. The at least one response message is used to update the current order status of all the outstanding orders. This updated status helps in the calculation of risk factor and traded volumes 435. Since the trading engine simply accepts or rejects the order depending upon the status of user message parameters, the overall latency in the trading system is greatly reduced. Also physically separated inspection engines provide operational flexibility. This makes it possible to forward the user messages, which are not marked to be rejected, to be forwarded to the trading system in less than 200 microseconds. Response messages from the trading system are preferably forwarded equally as fast.

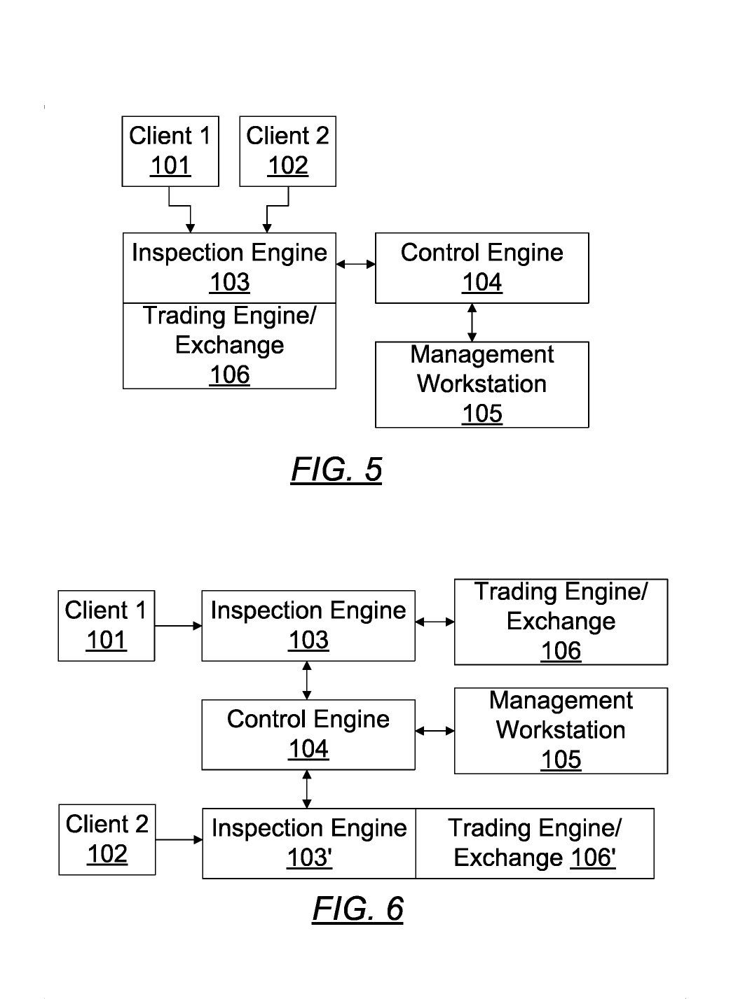

FIG. 5 shows yet another embodiment of the present invention. Here the inspection engine 103 is incorporated into the same physical device as that of the trading engine 106. The user message flow is similar to that in FIG. 1. In this embodiment, the latency caused due to communication between the physically separated inspection engine 103 and trading engine 106 of the configuration shown in FIG. 1 is reduced or eliminated. The inspection engine 103 simply signals internally to the trading engine 106 that a user message is to be rejected.

FIG. 6 shows another embodiment of the present invention. The user message flow is similar to that of FIG. 3. Here the inspection engine 103′ is incorporated into the same physical device as that of the trading engine 106′. In this embodiment, the latency caused due to communication between the physically separated inspection engine 103′ and trading engine 106′ of the configuration shown in FIG. 3 is reduced or eliminated. The inspection engine 103′ simply signals internally to the trading engine 106′ that a user message is to be rejected. In yet another embodiment not shown, both the inspection engines 103, 103′ may be incorporated into the trading engines 106, 106′ respectively. In this case, the inspection engines 103, 103′ can just signal through internal means that a message is to be rejected.

In one embodiment, upon receiving a response message responsive to a user message that has been rejected or an error response, an inspection engine further modifies at least one parameter and/or adding at least one parameter to the response message such that the at least one modified or added parameter reflects a cause for rejection of the user message. A client of the inspection engine can then retrieve and utilize the cause.

In another embodiment, the present invention may be implemented in an off-site processing or distributed processing architecture. Here the inspection engines along with the control engine may be present on plurality of servers on a network like internet. This type of network architecture can provide a single software application through the browser to multiple brokers and users. In this embodiment, the inspection engines and the control engine are normally placed at a geographically remote location. Further, the data can be accessed on an “on-demand” basis. In this embodiment, the clients and brokers only pay for what they use.

Thus, this method for monitoring, controlling and generating messages in a trading system incorporates at least one user device for accessing the software application and a trading engine. User messages are transmitted from the at least one user device to a server at an trading engine that maintains a list of all outstanding trade orders. The server comprises an inspection engine to monitor, control and collect parameters of the user messages.

1. A method for controlling at least one user message in a trading system comprising at least one inspection engine and at least one trading engine, wherein said at least one inspection engine generates said at least one user message corresponding to an outstanding trade order submitted by a client of said at least one inspection engine, said at least one user message comprises a risk factor and at least one parameter and said method comprises:
a. a calculating step of calculating said risk factor wherein a first risk factor of said at least one user message is calculated based on current market data and a current order status of all outstanding orders and a second risk factor of at least one previous user message is calculated based on said current market data and said current order status of all outstanding orders, wherein said current market data is received by said at least one inspection engine from at least one outside source relating to said at least one user message and said at least one previous user message;
b. a comparing step of comparing said risk factor with a predetermined range limit of risk factors and comparing said at least one parameter of said at least one user message with a predetermined range limit of said at least one parameter, whereby if a first condition exists such that said risk factor exceeds said predetermined range limit of said risk factor, said at least one parameter of said at least one user message is modified to an invalid value or if a second condition exists such that said at least one parameter exceeds said predetermined range limit of said at least one parameter, said at least one parameter is modified to an invalid value, or a combination of said first and second conditions whereby said at least one user message is treated as “out of range;”
c. a transmitting step of transmitting said at least one user message via a first communication means to a server of said at least one trading engine, wherein said server maintains a list of outstanding trade orders, whereby if said at least one user message is treated as “out of range,” said at least one user message is rejected and if said at least one user message is not treated as “out of range,” said at least one user message is added to said list of outstanding trade orders, thereby eliminating the need for maintaining states of said at least one user message and reducing an overhead corresponding to said transmitting step, wherein said overhead is incurred due to the need to specify the way said at least one user message is transmitted to said server; and
d. a receiving step of receiving at least one response message by said at least one inspection engine in response to said at least one user message, whereby said at least one response message comprises a normal response comprising one of an execution state, a change in said at least one parameter responsive to said at least one user message and a combination thereof, if said at least one user message is not rejected by said at least one trading engine or an error response if said at least one user message is rejected by said at least one trading engine.

2. The method as recited in claim 1, further comprising a step of one of modifying said at least one parameter, adding at least one parameter to said at least one response message, or a combination thereof such that said at least one modified or added parameter reflects a cause for rejection of said at least one user message.

3. The method as recited in claim 1, wherein said transmitting step is stateless within a message protocol said at least one user message operates in.

4. The method as recited in claim 1, wherein said at least one inspection engine is a software application functioning at a transport layer of a network stack of said trading system.

5. The method as recited in claim 1, wherein said at least one parameter of said at least one user message is selected from the group consisting of userId, volume, symbol, price, exchange, account, and combinations thereof.

6. The method as recited in claim 1, wherein said at least one outside source comprises trading exchanges, third party databases, and combinations thereof.

7. The method as recited in claim 1, wherein said at least one user message comprises at least one asset selected from the group consisting of shares, futures, options, currencies and commodities.

8. The method as recited in claim 1, wherein said current market data comprises market data selected from the group consisting of engine best ask prices, engine best bid prices, national best ask prices, national best bid prices, current buy value, current sell value, volatility of a particular trading asset, profit and loss information, margin, and volumes of trading assets.

9. The method as recited in claim 1, wherein said current market data is stored in a memory present in said at least one inspection engine.

10. The method as recited in claim 1, wherein said predetermined range limit of said at least one parameter and said predetermined range limit of risk factors are each defined by said client selected from the group consisting of a broker, a dealer and an administrator.

11. The method as recited in claim 1, wherein said comparing step further comprises filtering said at least one user message with filter criteria at said at least one inspection engine and treating said at least one user message as “out of range” if a third condition exists such that said filter criteria are not met.

12. The method as recited in claim 11, wherein said filter criteria comprise a criterion selected from the group consisting of restricted symbol lists, trade through verification, manual do-not-trade instructions, message rates, and combinations thereof.

13. The method as recited in claim 1, wherein said at least one inspection engine is a part of said at least one trading engine, wherein said at least one user message that is treated as “out of range” is communicated internally within said inspection engine via internal signaling, thereby reducing a latency caused by communication between said at least one inspection engine and said at least one trading engine.

14. The method as recited in claim 1, wherein said at least one response message comprises a response message selected from the group consisting of a new order booked message, a CFO response, a cancel report and a fill report.

15. The method as recited in claim 1, wherein said transmitting step is completed in less than 200 microseconds.

16. The method as recited in claim 1, wherein said method is implemented in a distributed processing architecture.

17. The method as recited in claim 1, further comprising:
a. a step of providing a control engine serving as a central point for collecting said at least one parameter of said at least one inspection engine and at least one parameter from one or more second inspection engines to form collected parameters and carrying out said comparing, transmitting and receiving steps; and
b. a step of providing a management workstation that is functionally linked to said control engine, wherein said management workstation provides manual access to said collected parameters.

18. The method as recited in claim 17, wherein said control engine is a central node for communicating to said at least one inspection engine and said one or more second inspection engines.

19. The method as recited in claim 17, wherein said management workstation comprises a means for:
a. monitoring said at least one parameter for said at least one user message categorized according to a specific client, symbol or gateway;
b. monitoring said risk factor including said first and second risk factors categorized according to a specific client;
c. placing an order on behalf of a specific client;
d. setting said predetermined range limit of risk factors and said predetermined range limit of said at least one parameter; and
e. shutting down an order for a specific client, symbol or gateway.

20. A method for reducing latency in a trading system comprising at least one inspection engine and at least one trading engine, wherein said at least one inspection engine generates at least one user message corresponding to an outstanding trade order submitted by a client of said at least one inspection engine, wherein said at least one user message comprises a risk factor and at least one parameter and said method comprises:
a. a calculating step of calculating said risk factor wherein a first risk factor of said at least one user message is calculated based on current market data and a current order status of all outstanding orders and a second risk factor of at least one previous user message is calculated based on said current market data and said current order status of all outstanding orders, wherein said current market data is received by said at least one inspection engine from at least one outside source relating to said at least one user message and said at least one previous user message;
b. a comparing step of comparing said risk factor with a predetermined range limit of risk factors and comparing said at least one parameter of said at least one user message with a predetermined range limit of said at least one parameter, whereby if a first condition exists such that said risk factor exceeds said predetermined range limit of said risk factor, said at least one parameter of said at least one user message is modified to an invalid value or if a second condition exists such that said at least one parameter exceeds said predetermined range limit of said at least one parameter, said at least one parameter is modified to an invalid value, or a combination of said first and second conditions whereby said at least one user message is treated as “out of range;”
c. a transmitting step of transmitting said at least one user message via a first communication means to a server of said at least one trading engine, wherein said server maintains a list of outstanding trade orders, whereby if said at least one user message is treated as “out of range,” said at least one user message is rejected and if said at least one user message is not treated as “out of range,” said at least one user message is added to said list of outstanding trade orders, thereby eliminating the need for maintaining states of said at least one user message and reducing an overhead corresponding to said transmitting step, wherein said overhead is incurred due to the need to specify the way said at least one user message is transmitted to said server; and
d. a receiving step of receiving at least one response message by said at least one inspection engine in response to said at least one user message, whereby said at least one response message comprises a normal response comprising one of an execution state, a change in said at least one parameter responsive to said at least one user message and a combination thereof, if said at least one user message is not rejected by said at least one trading engine or an error response if said at least one user message is rejected by said at least one trading engine.

21. The method as recited in claim 20, further comprising a step of one of modifying said at least one parameter, adding at least one parameter to said at least one response message, and a combination thereof, such that said at least one modified or added parameter reflects a cause for rejection of said at least one user message.

22. The method as recited in claim 20, wherein said transmitting step is completed in less than 200 microseconds.

23. The method as recited in claim 20, wherein said transmitting step is stateless within a message protocol said at least one user message operates in.

24. The method as recited in claim 20, wherein said at least one inspection engine is a software application functioning at a transport layer of a network stack of said trading system.

25. The method as recited in claim 20, wherein said predetermined range limit of said at least one parameter and said predetermined range limit of risk factors are each defined by said client selected from the group consisting of a broker, a dealer and an administrator.

26. The method as recited in claim 20, wherein said comparing step further comprises filtering said at least one user message with filter criteria at said at least one inspection engine and treating said at least one user message as “out of range” if a third condition exists such that at least one of said filter criteria is not met.

27. The method as recited in claim 26, wherein each of said filter criteria is selected from the group consisting of restricted symbol lists, trade through verification, manual do-not-trade instructions, message rates, and combinations thereof.

28. The method as recited in claim 20, wherein said at least one inspection engine is a part of said at least one trading engine, wherein said at least one user message that is treated as “out of range” is communicated internally internal signalling, thereby reducing the latency caused by communication between said at least one inspection engine and said at least one trading engine.

29. The method as recited in claim 20, wherein said method is implemented in a distributed processing architecture.

30. A system for reducing latency in a trading system comprising:
a. at least one inspection engine that collects current market data from at least one outside source relating to at least one user message and a memory, wherein a risk factor is calculated that comprises a first risk factor that is calculated for said at least one user message based on said current market data and a current order status of all outstanding orders and a second risk factor that is calculated for at least one previous user message based on said current market data and said current order status of all outstanding orders and said at least one user message is saved in said memory;
b. a means for comparing said risk factor with a predetermined range limit of risk factors and comparing at least one parameter of said at least one user message with a predetermined range limit of said at least one parameter, whereby if a first condition exists such that said risk factor exceeds said predetermined range limit of said risk factor, said at least one parameter of said at least one user message is modified to an invalid value or if a second condition exists such that said at least one parameter exceeds said predetermined range limit of said at least one parameter, said at least one parameter is modified to an invalid value, or a combination of said first and second conditions thereof, whereby said at least one user message is treated as “out of range;”
c. a means for transmitting said at least one user message via a first communication means to a server of at least one trading engine in a period, wherein said server maintains a list of outstanding trade orders, whereby if said at least one user message is treated as “out of range,” said at least one user message is rejected and if said at least one user message is not treated as “out of range,” said at least one user message is added to said list of outstanding trade orders, thereby negating the need for maintaining states of said at least one user message and reducing a latency corresponding to said means for transmitting said at least one user message; and
d. a means for receiving at least one response message by said at least one inspection engine in response to said at least one user message, whereby said at least one response message comprises a normal response comprising one of an execution state a change in said at least one parameter responsive to said at least one user message and a combination thereof, if said at least one user message is not rejected by said at least one trading engine or an error response if said at least one user message is rejected by said at least one trading engine.

31. The system as recited in claim 30, wherein said means for transmitting said at least one user message is stateless within a message protocol said at least one user message operates in.

32. The system as recited in claim 30, wherein said period is less than 200 microseconds.

33. The system as recited in claim 30, wherein said at least one inspection engine is a software application functioning at a transport layer of a network stack of said trading system.

34. The system as recited in claim 30, wherein said at least one parameter of said at least one user message is selected from the group consisting of userId, volume, symbol, price, exchange, account, and combinations thereof.

35. The system as recited in claim 30, wherein said at least one outside source comprises trading exchanges, third party databases, and combinations thereof.

36. The system as recited in claim 30, wherein said means for comparing said risk factor with said predetermined range limit of risk factors and said means for comparing said at least one parameter of said at least one user message with said predetermined range limit of said at least one parameter further comprises filtering said at least one user message with filter criteria at said at least one inspection engine and treating said at least one user message as “out of range” if a third condition exists such that at least one of said filter criteria is not met.

37. The system as recited in claim 36, wherein each of said filter criteria is selected from the group consisting of restricted symbol lists, trade through verification, manual do-not-trade instructions, message rates, and combinations thereof.
